(19) United States
(12) Patent Application Publication
(10) Pub. No.: US 2024/0308080 A1
(43) Pub. Date: Sep. 19, 2024

(54) SYSTEMS AND METHODS FOR AUTONOMOUS ROAD SEALING

(71) Applicant: Vista Solutions Inc., Windsor (CA)

(72) Inventors: Robertson Brown, Amherstburg (CA); Peter Denzinger, Lasalle (CA); Brandon Pineda, Windsor (CA); Dean Scarlett, Lakeshore (CA); Michael Sirizzotti, Windsor (CA)

(21) Appl. No.: 18/183,994

(22) Filed: Mar. 15, 2023

(51) Int. Cl. B25J 9/16; B05C 5/02; B25J 15/00; E01C 11/00; E01C 23/01; G06T 7/00; G06T 7/11

(52) U.S. Cl. CPC B25J 9/1697; B05C 5/02; B25J 9/1664; B25J 15/0019; E01C 11/005; E01C 23/01; G06T 7/0002; G06T 7/11; G06T 2207/20021; G06T 2207/20081

(57) ABSTRACT

A method for programming a robot to autonomously fill cracks in a pavement. The robot fills the cracks using a nozzle having a puck width. The method comprises the steps of obtaining an image of the pavement, identifying one or more crack regions in the pavement from the image, generating a path to fill the one or more crack regions, determining a volume of sealant to fill the one or more crack regions along the path, generating instructions to fill the one or more crack regions using the path and the volume of the sealant, and sending the instructions to the robot.

### BACKGROUND OF THE INVENTION

### 1. Technical Field

The present invention relates to systems and methods for autonomously identifying and filling cracks in pavement. More particularly, the invention relates to systems and methods for identifying cracks in the pavement and for programming a robot to autonomously fill the cracks.

### 2. Description of Related Art

Current methods for identifying and filling cracks in pavement are performed manually. This can be a time-consuming process, which involve inherent safety risks for workers. Moreover, crack filling needs to be performed during the day when there is enough daylight for the workers to see the pavement.

### SUMMARY OF THE INVENTION

The present invention relates to systems and methods for identifying cracks in the pavement and for programming a robot to autonomously fill the cracks. Having a robot perform crack filling not only reduces safety concerns resulting from high-speed traffic and distracted drivers, but it also improves the quality of the cracks that are filled because a robot is more likely to provide consistent results. Moreover, the present invention is more efficient because it provides a system that can fill cracks during the day or at night when the robot is less likely to obstruct traffic.

According to one aspect of the invention, a method is provided for programming a robot to autonomously fill cracks in a pavement. The robot fills the cracks using a nozzle having a puck width. The method comprises the steps of obtaining an image of the pavement, identifying one or more crack regions in the pavement from the image, generating a path to fill the one or more crack regions, determining a volume of sealant to fill the one or more crack regions along the path, generating instructions to fill the one or more crack regions using the path and the volume of the sealant, and sending the instructions to the robot.

According to another aspect of the invention, a system is provided for programming a robot to autonomously fill cracks in a pavement. The robot fills the cracks using a nozzle having a puck width. The system comprises a camera and a processor. The camera is configured to obtain an image of the pavement. The processor is configured to identify one or more crack regions in the pavement from the image, generate a path to fill the one or more crack regions, determine a volume of sealant to fill the one or more crack regions along the path, generate instructions to fill the one or more crack regions using the path and the volume of the sealant, and send the instructions to the robot.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 shows an autonomous road sealing system according to embodiments of the present invention;

FIG. 2 illustrates a front view of the cameras from the system of FIG. 1;

FIG. 3 illustrates a side view of the cameras and lasers from the system of FIG. 1;

FIG. 4 illustrates a top view of the cameras and lasers from the system of FIG. 1;

FIG. 5 is a flow diagram illustrating a method for autonomously sealing road cracks, in accordance with the present invention;

FIG. 6 is a flow diagram illustrating an exemplary method for crack extraction;

FIG. 7 is a flow diagram illustrating an exemplary method for pre-processing an image;

FIGS. 8A-8D show exemplary changes to an image during the crack extraction process of FIG. 6;

FIGS. 9A-9B are a flow diagram illustrating an exemplary method for applying AI post-processing;

FIGS. 10A-10J show exemplary changes to an image during the post-processing steps of FIGS. 9A-9B;

FIG. 11 is a flow diagram illustrating an exemplary method for merging all information for each camera;

FIGS. 12A-12E show exemplary changes to an image during the merging process of FIG. 11;

FIGS. 13A-13C are a flow diagram illustrating an exemplary method for generating a path;

FIGS. 14A-14M show exemplary changes to an image during the path generating process of FIGS. 13A-13C;

FIG. 15 is a flow diagram illustrating an exemplary method for reducing the number of points in the path;

FIGS. 16A-16B show exemplary changes to an image during the reducing process of FIG. 15;

FIGS. 17A-17B are a flow diagram illustrating an exemplary method for ensuring minimum point density;

FIG. 18 shows the exemplary unordered path resulting after performing the process of FIGS. 17A-17B;

FIGS. 19A-19B are a flow diagram illustrating an exemplary method for optimizing the path;

FIGS. 20A-20B are a flow diagram illustrating an exemplary method for ordering the path;

FIG. 21 shows the exemplary ordered path resulting after performing the process of FIGS. 19A-19B;

FIG. 22A-22B are a flow diagram illustrating an exemplary method for checking for obstacles;

FIG. 23 is a flow diagram illustrating an exemplary method for point calibration; and

FIG. 24 is a flow diagram illustrating an exemplary method for converting the coordinates into real world coordinates.

### DETAILED DESCRIPTION OF EXAMPLE EMBODIMENTS

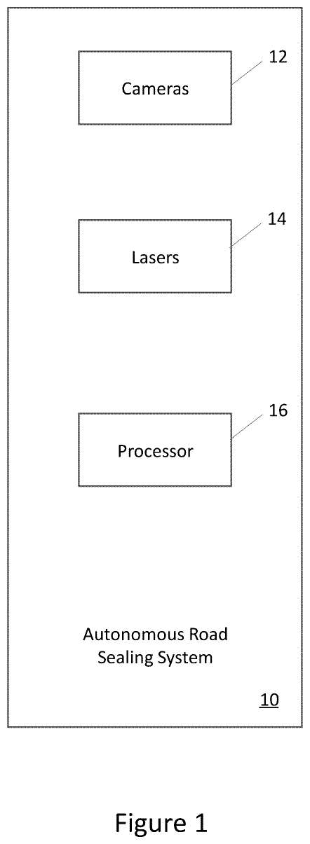

FIG. 1 depicts a schematic illustration of an autonomous road sealing system 10 suitable for practicing methods and systems consistent with the present invention. The system 10 includes cameras 12, lasers 14 and a processor 16. The cameras 12 capture images of the pavement 18 while the lasers 14 provide the light source for the cameras 12. The processor 16 processes the images from the cameras 12, identifies the cracks in the pavement from the images, and generates instructions for a robot to autonomously fill the cracks using a nozzle having a puck width.

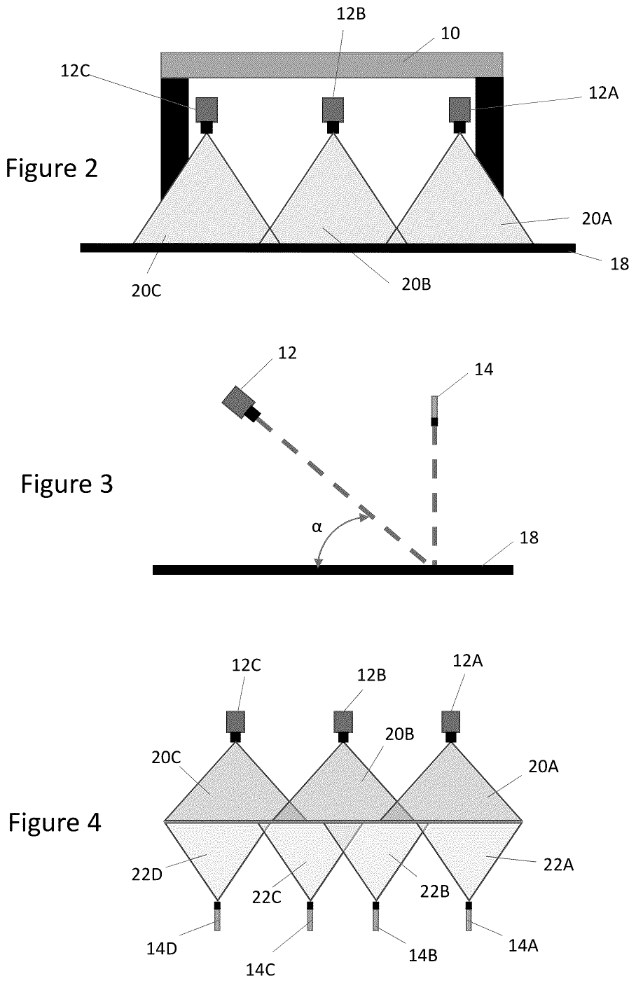

Referring to FIGS. 2-4, in one embodiment, the autonomous road sealing system 10 includes three cameras 12A-12C and four lasers 14A-14D. Each of the cameras 12A-12C has a field of view 20A-20C, which overlap to span the reach of the system 10 across the pavement 18. As reflected in FIG. 3, each laser 14 focuses the light directly onto the pavement while each camera 12 is mounted at an angle a from the pavement 18. Each of the lasers 14A-14D has a field of view 22A-22D, which overlap and also span the reach of the system 10 to ensure that each camera 12A-12C has sufficient lighting to obtain useful images of the pavement 18.

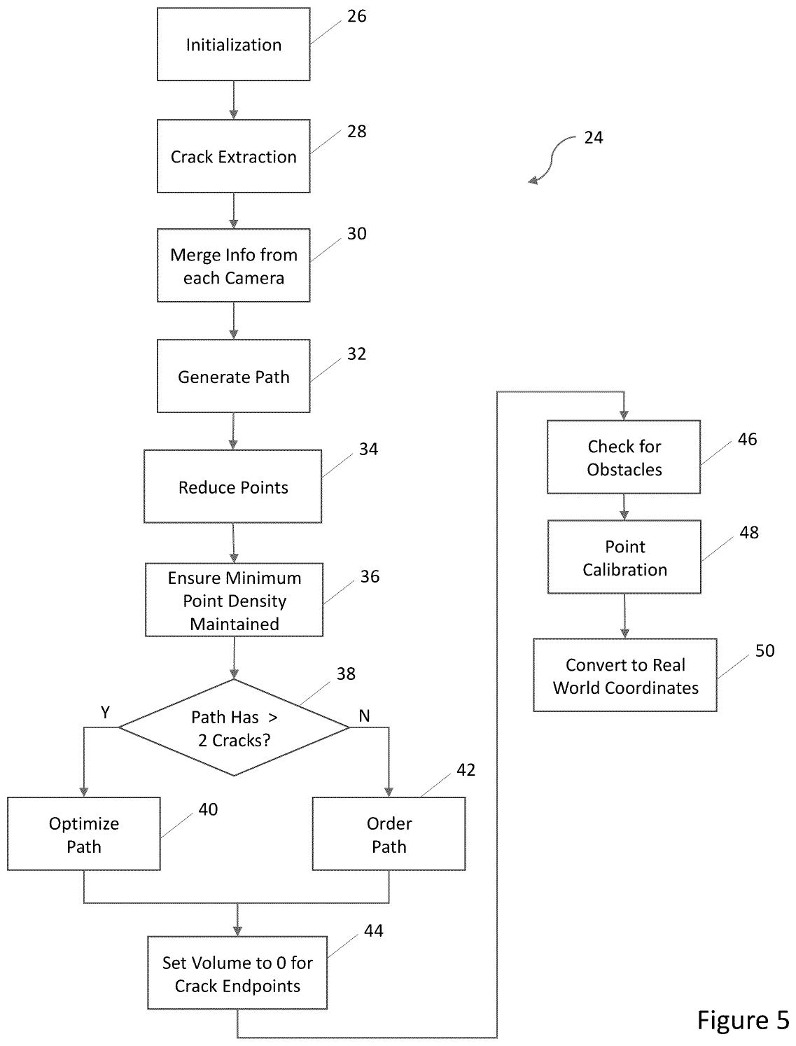

FIG. 5 shows a flow chart illustrating an exemplary method 24 for autonomously identifying and filling road cracks in accordance with the present invention. The system 10 performs an initialization step (step 26). For example, the system 10 records the latest known position of the robot and loads and optimizes relevant AI models. The system 10 also verifies that each of the lasers 14 is operating correctly. Referring to FIGS. 2-4, to verify that each of the lasers 14 is operating correctly, the system 10 initially checks the intensity of the image from the driver camera 12A. If the intensity of the image from the driver camera 12A is mostly dark, the system 10 will mark the first laser 14A as not working. Otherwise, the system 10 will confirm that the first laser 14A is working properly. The system 10 then checks the intensities of the images from both the left and right side of the center camera 12B. If the intensity of the image from the left side of the center camera 12B is mostly dark, the system 10 will mark the second laser 14B as not working. Otherwise, the system 10 will confirm that the second laser 14B is working properly. If the intensity of the image from the right side of the center camera 12B is mostly dark, the system 10 will mark the third laser 14C as not working. Otherwise, the system 10 will confirm that the third laser 14C is working properly. The system 10 then checks the intensity of the image from the passenger camera 12C. If the intensity of the image from the passenger camera 12C is mostly dark, the system 10 will mark the fourth laser 14D as not working. Otherwise, the system 10 will confirm that the fourth laser 14D is working properly. If the system 10 determines that any of lasers 14A-14D is not working properly, the system 10 cancels the inspection, merges all of the camera images to display the information to the operator, and notifies the operator that at least one of the lasers 14A-14D needs servicing. If the system 10 determines that all lasers 14A-14D are working, then the system 10 will proceed with the method 24 for autonomously identifying and filling road cracks.

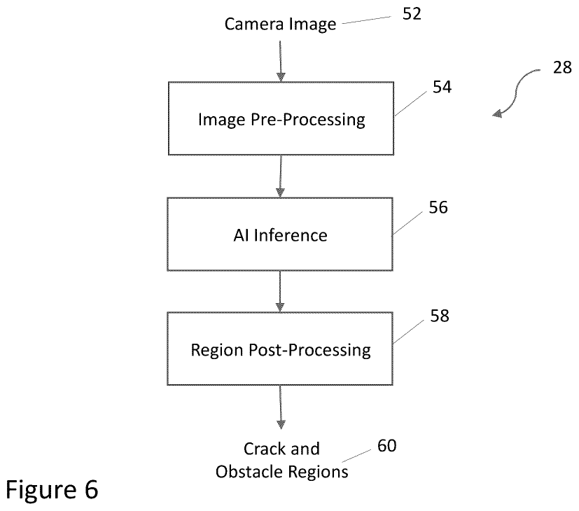

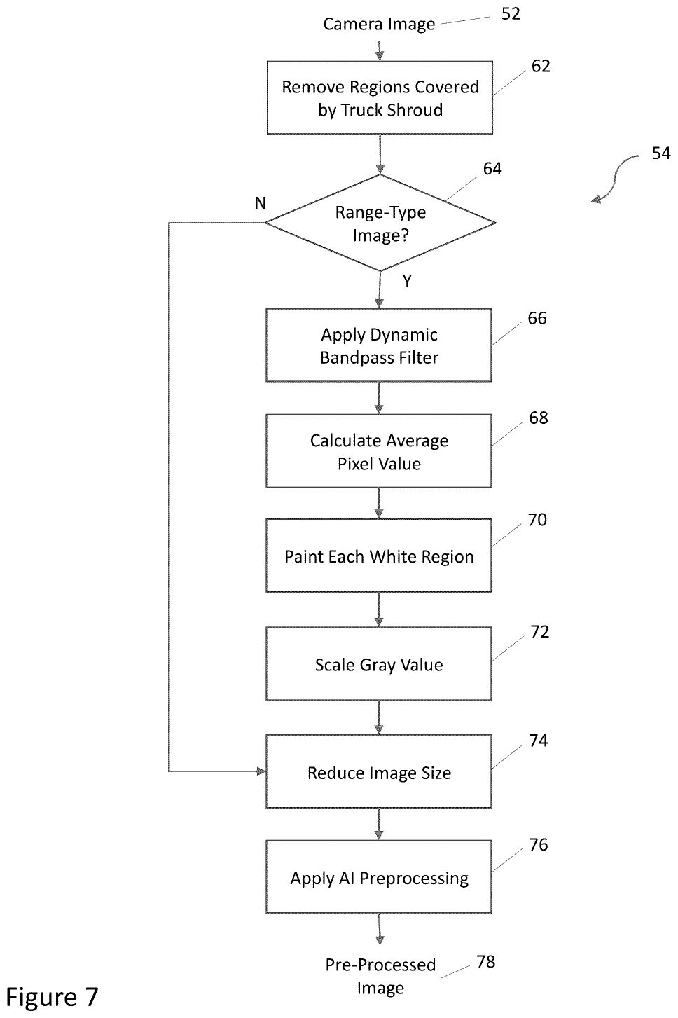

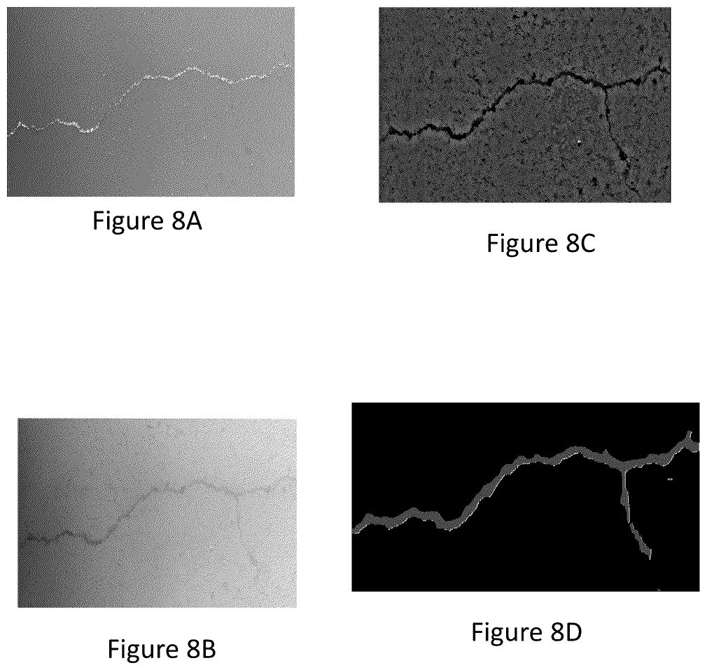

Returning to FIG. 5, after initialization (step 26), the system 10 performs crack extraction (step 28). FIG. 6 reflects exemplary steps performed by the system 10 during crack extraction. The system 10 initially preprocesses the camera image 52 (step 54). FIG. 7 reflects exemplary steps performed by the system 10 when preprocessing the camera image 52. For each camera image 52, the system 10 removes the regions covered by truck shroud (step 62). Each camera image 52 includes a range-type image and an intensity image. For each range-type image (step 64), the system 10 applies a dynamic bandpass filter to remove white noise (step 66). The system 10 then calculates the average pixel value for the surrounding area of each white region (step 68), and then paints each white region with its respective surrounding average (step 70). FIGS. 8A and 8B show an exemplary range image before and after painting each region with its respective surrounding average. The system 10 then scales gray values to byte format (0-255) (step 72), as reflected in FIG. 8C. The system 10 then reduces the image size for AI inference (step 74). The system 10 also reduces the image size for AI inference (step 74) if at step 64 it determines that the image is not a range image. The system 10 then applies internal AI preprocessing (step 76) to obtain a pre-processed image 78.

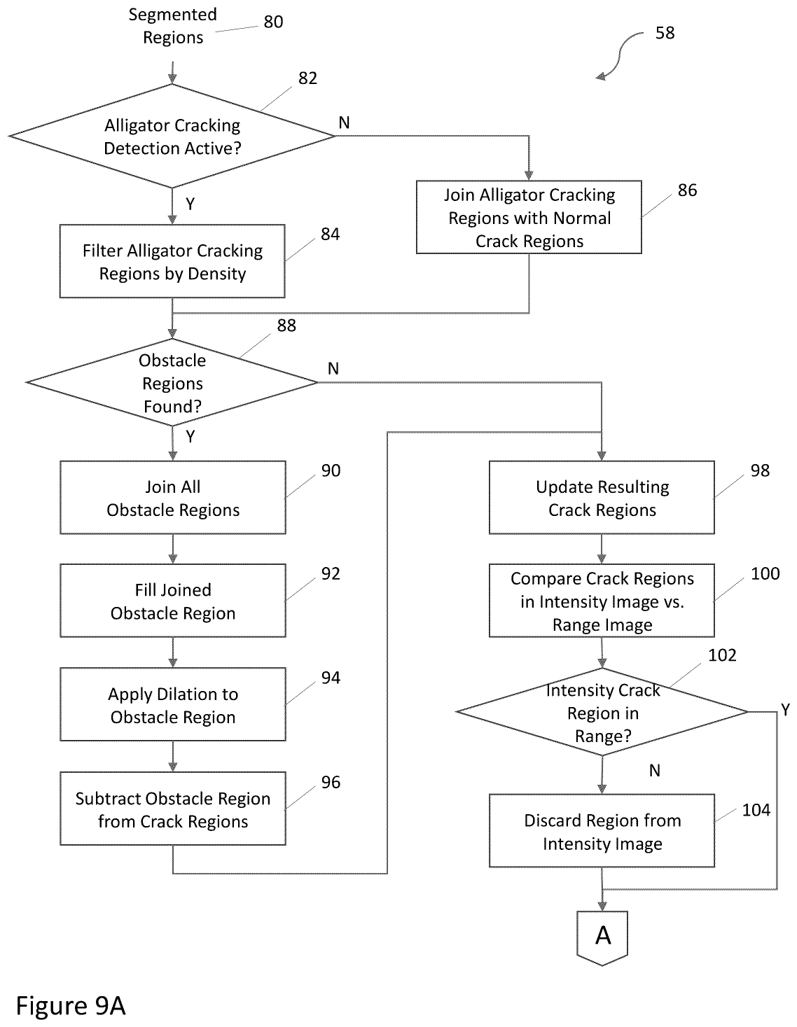

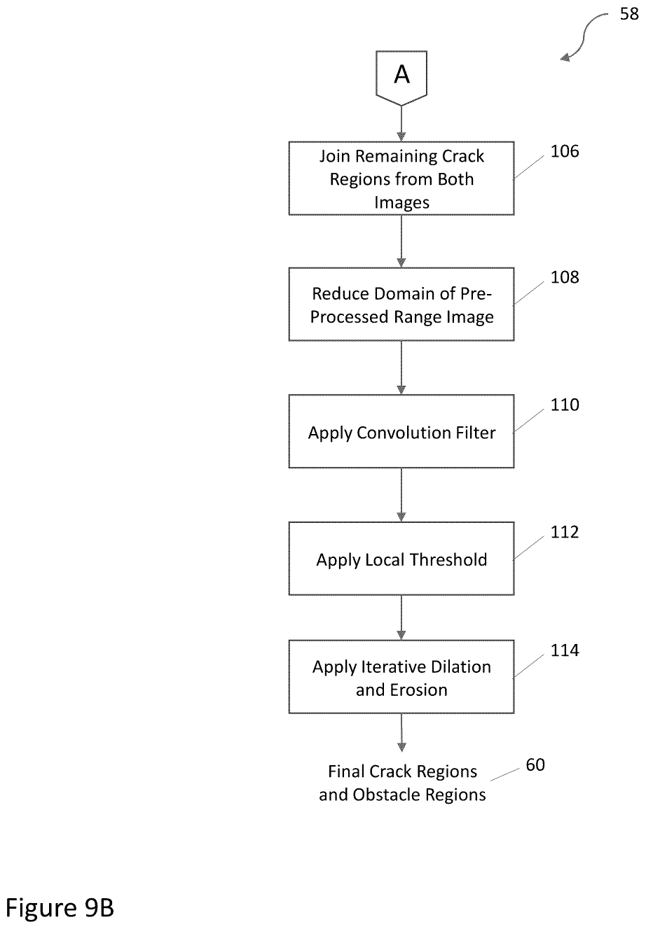

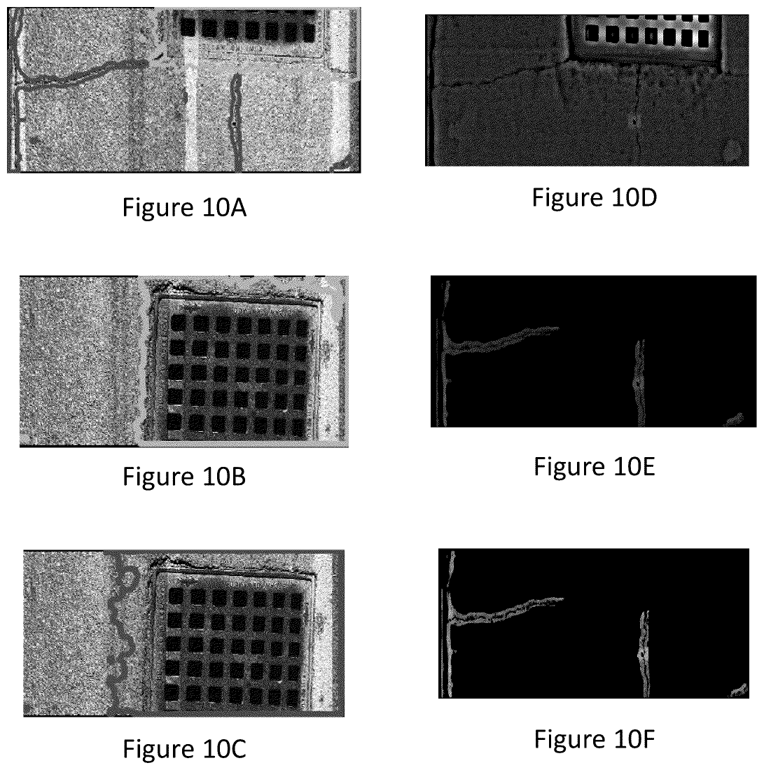

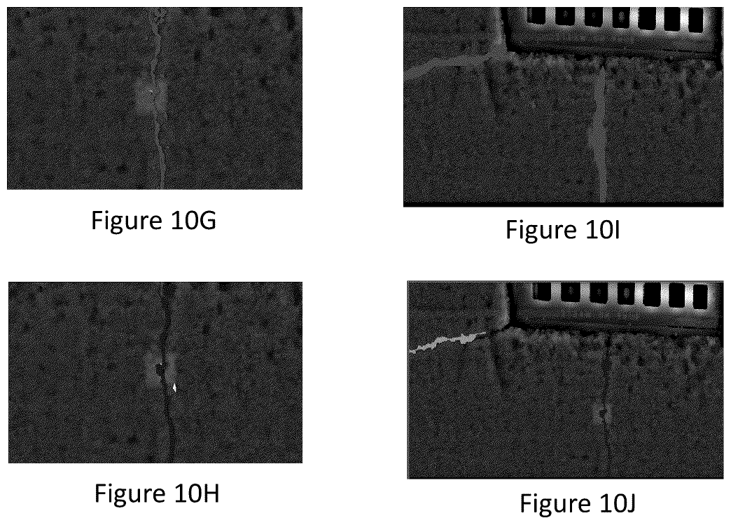

Returning to FIG. 6, after pre-processing (step 54), the system 10 performs AI inference (step 56). During this step, the system 10 applies an AI deep learning model to the pre-processed images to obtain segmented images 80, as reflected in FIG. 8D. The system 10 then performs post-processing steps on the segmented regions 80 (step 58) to identify the final crack and obstacle regions 60. FIGS. 9A-9B reflect exemplary steps performed by the system 10 to post-process the segmented regions 80. The system 10 initially determines whether alligator cracking detection is active (step 82). If alligator cracking detection is active, the system 10 filters the alligator cracking regions by density and adds them to the obstacle regions so that they are not filled (step 84). Otherwise, the system 10 joins the alligator cracking regions with the normal crack regions (step 86). The system 10 then determines whether any obstacle regions are found (step 88). If obstacle regions are found, the system 10 joins all obstacle regions (step 90). FIG. 10A shows an exemplary image with joined obstacle regions identified in blue with the surrounding crack regions identified in red. The system 10 then fills the joined obstacle region to avoid leaving cracks inside (step 92). The system 10 then applies dilation to the obstacle region to avoid filling the cracks near the obstacles (step 94). FIGS. 10B and 10C show an exemplary image with an obstacle region before and after dilation. The system 10 subtracts from the crack regions any area intersecting an obstacle region (step 96), and updates the resulting crack regions (step 98). The system 10 also updates the resulting crack regions (step 98) if at step 88 it did not find any obstacle regions in the image. The system 10 compares crack regions found in the intensity image versus crack regions found in the range image (step 100), and determines whether the intensity crack region is also in the range region (step 102). If the intensity crack region is not also in the range crack region, the system 10 discards the region from the intensity image as noise (step 104). The system 10 then joins the remaining crack regions from both images (step 106, FIG. 9B), and reduces the domain of the pre-processed range image to the joined crack regions (step 108). FIG. 10D shows an exemplary domain of the pre-processed range image and FIG. 10E shows the corresponding joined crack regions. The system 10 applies a convolution filter to the resulting image to enhance the crack contrast (step 110), as reflected in FIG. 10F. The system 10 then applies a local threshold to get the actual crack inside the reduced image (step 112), and applies iterative dilation and erosion to connect the adjacent crack segments (step 114) to obtain the final crack regions and obstacle regions 60. FIGS. 10G and 10H show an exemplary image before and after applying iterative dilation and erosion, and FIGS. 10I and 10J show an exemplary image before and after performing the post-processing steps of FIGS. 9A-9B.

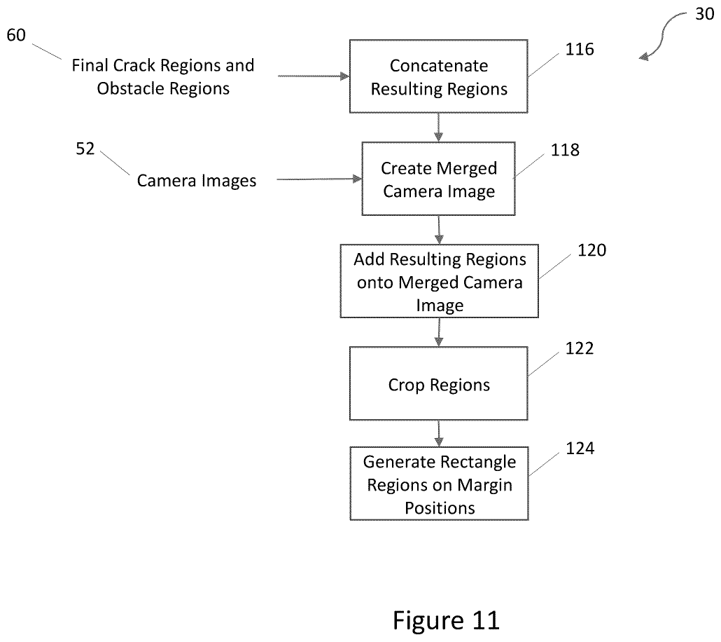

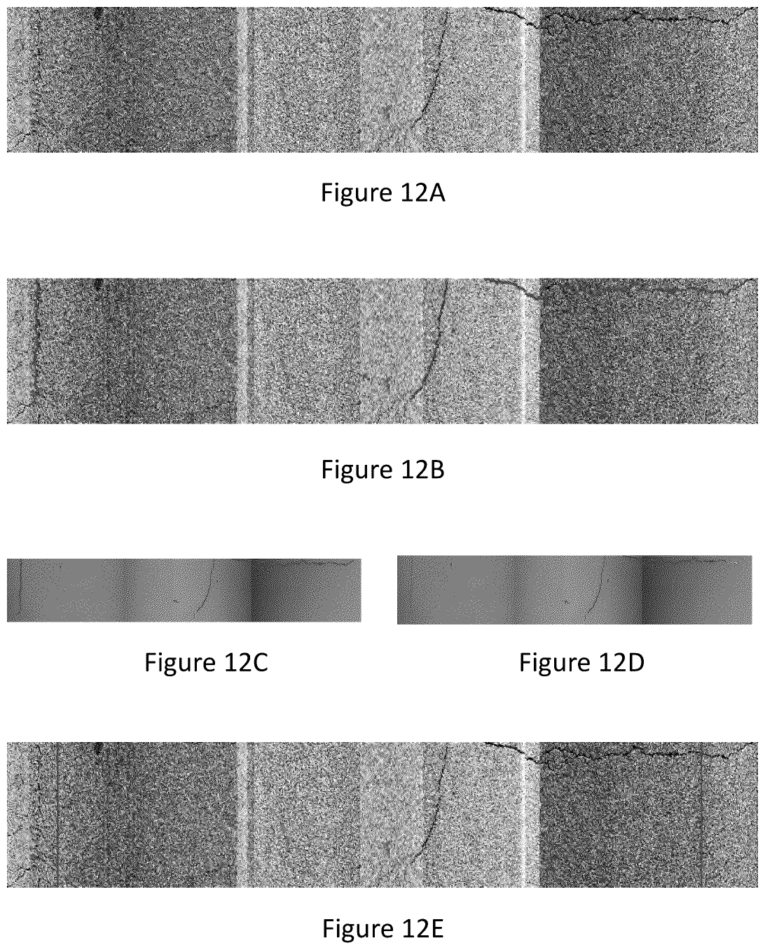

Returning to FIG. 5, after crack extraction (step 28), the system 10 merges all of the information from each camera (step 30). FIG. 11 reflects exemplary steps performed by the system 10 to merge the information. The system 10 concatenates the final crack regions and obstacle regions 60 from each of the cameras (step 116). The system 10 also creates a merged camera image by stitching each camera image 52 into one large continuous image (step 118). This step is performed for both the intensity images and the range images. FIG. 12A shows all of the camera images merged into one continuous image. The system 10 then adds the final crack regions and obstacle regions 60 to the merged image to create a large continuous region (step 120), as reflected in FIG. 12B. The system 10 then crops the merged region using margin parameters (step 122). FIG. 12C shows the merged region before cropping, and FIG. 12D shows the merged region after cropping. The system 10 also displays the margin parameters on the merged image (step 124), as reflected in FIG. 12E.

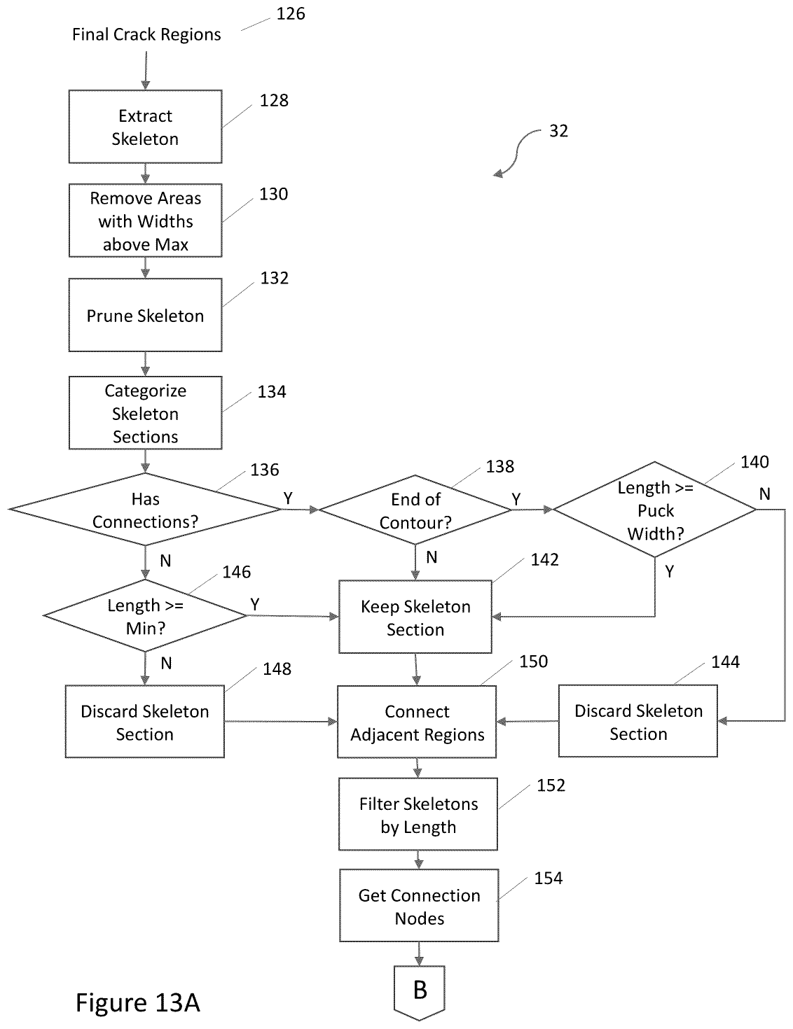

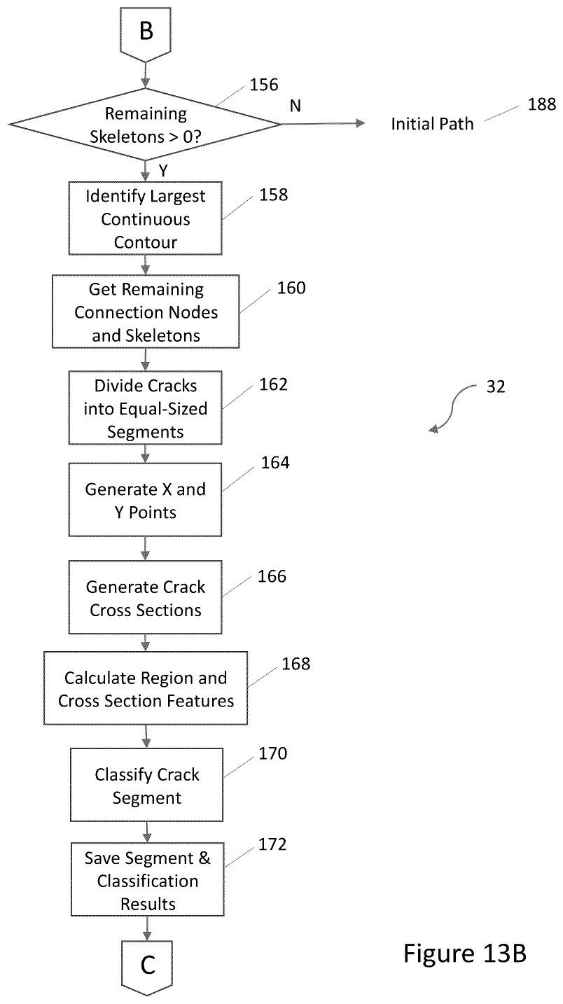

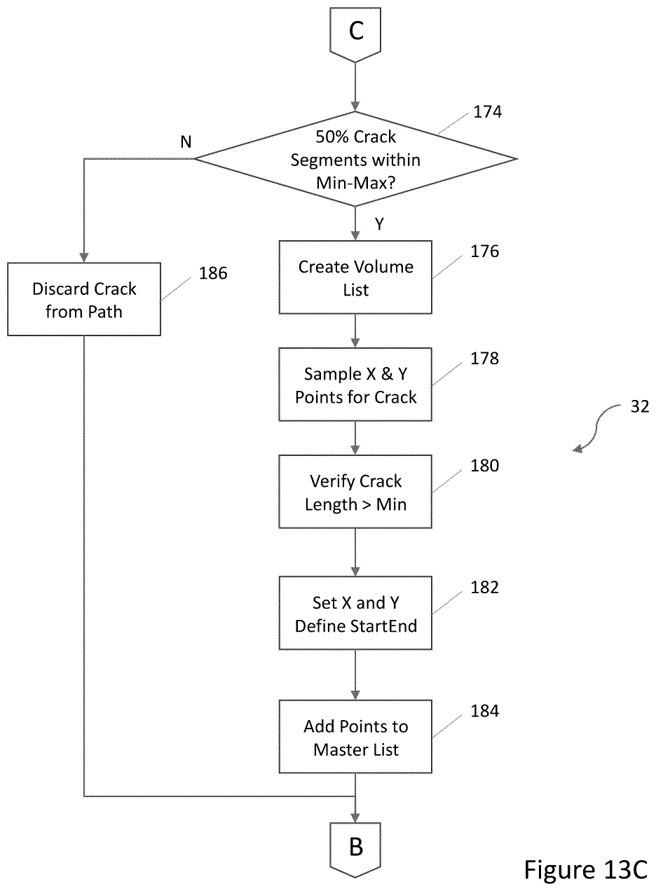

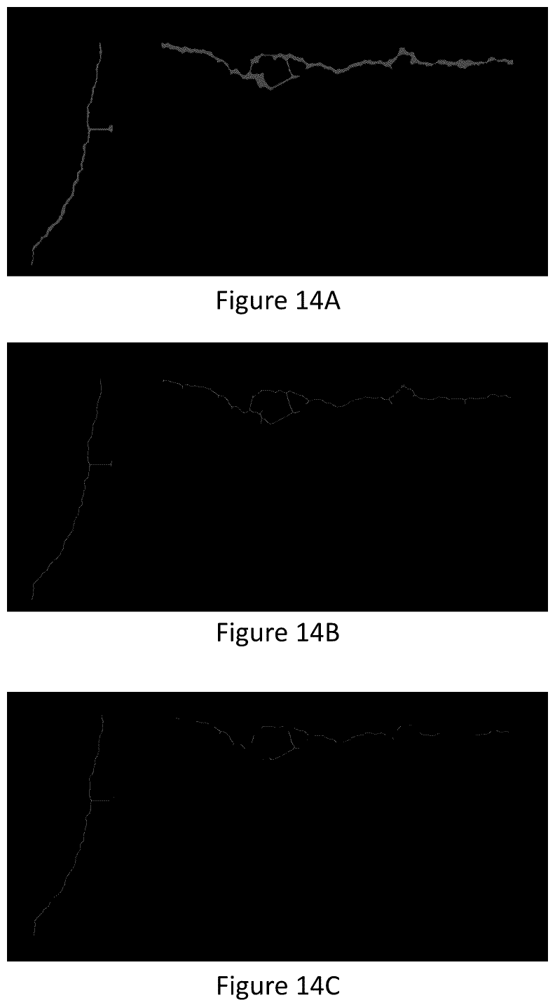

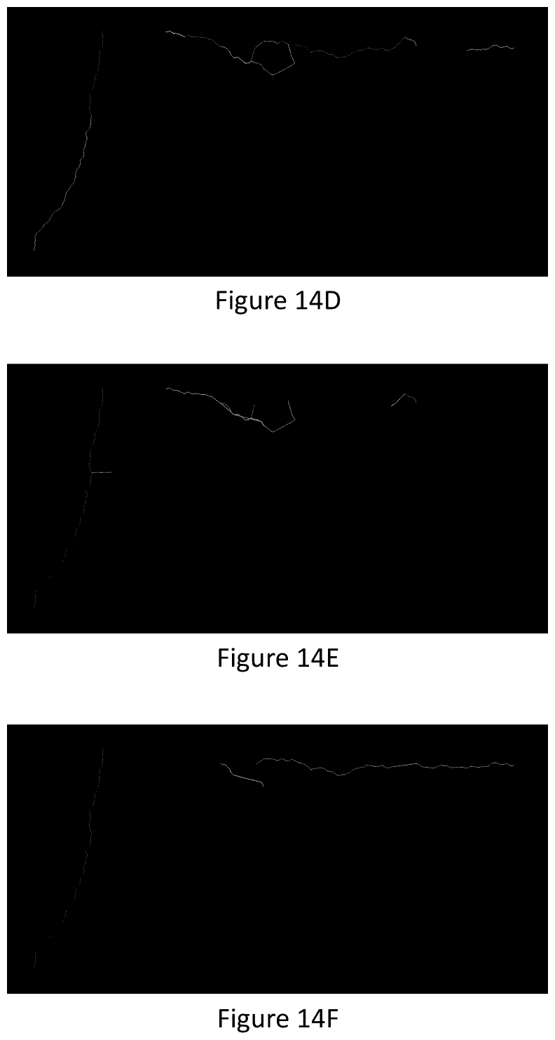

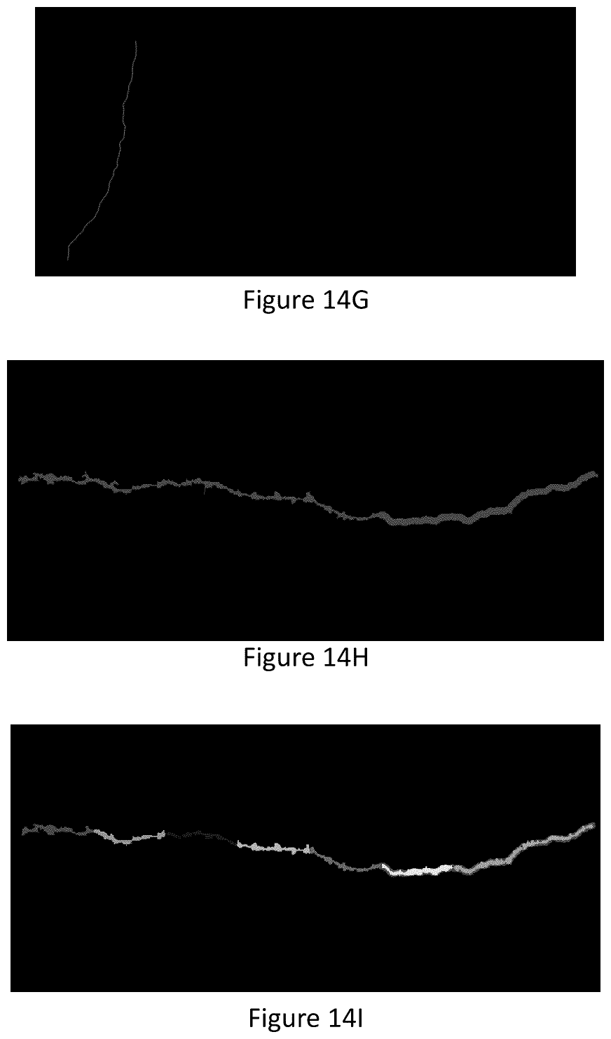

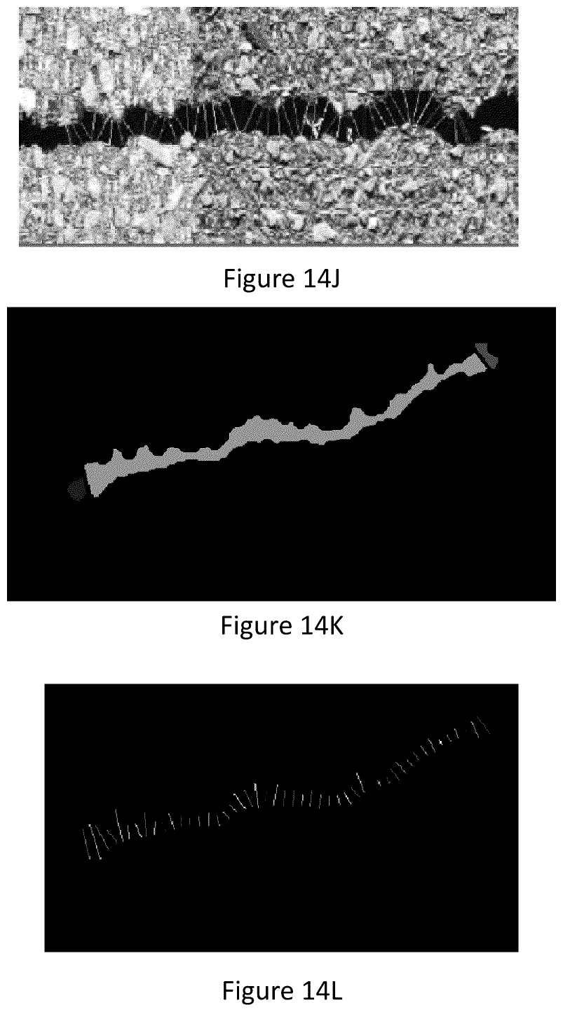

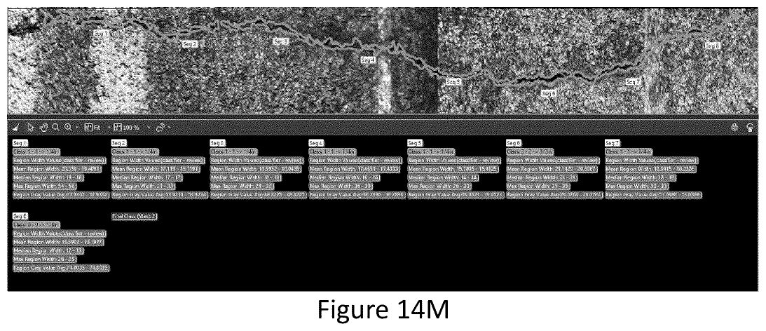

Returning to FIG. 5, after merging all of the information from each camera, the system 10 generates a path (step 32). FIGS. 13A-13C reflect exemplary steps performed by the system 10 to generate a path. The system 10 initially extracts a skeleton from the final crack regions 126 (step 128). To extract a skeleton, the system 10 erodes the crack regions 126 down to lines. FIG. 14A shows exemplary final crack regions 126, and FIG. 14B shows the corresponding skeleton. The system 10 also removes the areas on the final crack regions 126 having a width greater than a maximum width (step 130), as reflected in FIG. 14C. The system 10 then prunes the remaining skeleton by removing small branches from the skeleton (step 132). The system 10 then categorizes each skeleton section depending on the number of connection nodes within the skeleton (step 134). The system 10 determines whether the skeleton section has connections (step 136). If the skeleton section has connections, the system 10 determines whether the skeleton section is the end of a contour (step 138). If the skeleton section is the end of a contour, then the system 10 determines whether the length of the skeleton section is greater than or equal to the puck width (step 140). If the length is greater than or equal to the puck width, the system 10 keeps the skeleton section (step 142). Otherwise, it discards the skeleton section (step 144). If at step 138 the system 10 determines that the skeleton section is not the end of a contour, then the system 10 keeps the skeleton section (step 142). If at step 136 the system 10 determines that the skeleton section does not have connections, the system 10 determines whether the length of the skeleton is greater than or equal to a minimum (step 146). If the length is greater than or equal to the minimum, the system 10 keeps the skeleton section (step 142). Otherwise, the system 10 discards the skeleton section (step 148).

After determining whether to keep or discard each skeleton section at steps 142, 144 and 148, the system 10 connects adjacent regions for all remaining skeleton sections (step 150). FIG. 14D shows the skeleton before connecting adjacent regions, and FIG. 14E shows the skeleton after connecting adjacent regions. The system 10 filters the remaining skeletons by length (step 152), as reflected in FIG. 14F. The system 10 also gets all connection nodes for the remaining skeletons (step 154).

Referring to FIG. 13B, for each skeleton (step 156), the system 10 identifies the largest continuous contour (step 158), reflected in FIG. 14G, and gets the remaining connection nodes and skeletons (step 160). The system 10 divides each full crack (i.e., each continuous contour on the skeleton) into equal-sized segments (step 162). FIGS. 14H and 14I show an exemplary full crack before and after dividing it into equal-sized segments. For each crack segment skeleton, the system 10 generates X and Y points at a rate of every 10 pixels (step 164), and builds crack cross sections from the center of the skeleton to the edge of the crack region for every point (step 166). FIG. 14J shows exemplary cross sections on a crack, and FIGS. 14K and 14L show an exemplary crack segment before and after generating crack cross sections for every point. The system 10 calculates region and cross section features (step 168). For example, the system 10 calculates mean length of the cross-sections, median length of the cross-sections, maximum length of the cross-sections, average gray value of the crack segment region in the enhanced image. The average gray value of the crack segment may be used assist in distinguishing between ⅛ and ¼ inch cracks because the thin crack regions tend to be very noisy. The system 10 also classifies crack segment running features through a pre-trained multi-layer perceptron (MLP) classifier (step 170), and saves the segment and classification results to analyze the full crack (step 172). For example, the MLP classifier may classify 9 different crack classes depending on the cross-sectional lengths of the crack segment. The crack classification may be used to determine the amount of sealant used to fill the crack (i.e., may be used to determine the sealant “volume”). FIG. 14M shows an exemplary crack segments classification and corresponding features.

Referring to FIG. 13C, the system 10 then determines whether 50% of the crack segments are between the minimum and maximum (step 174). If 50% of the crack regions are within the minimum and maximum, the system 10 creates a volume list using each crack segment class (step 176). The system 10 also samples X and Y points for the whole crack at a rate of every 10 pixels (step 178). The system 10 verifies that each crack length is above the minimum crack length parameter (step 180). The system 10 then categorizes each point on the crack by determining the X and Y coordinates and defining the StartEnd for each point on the contour (step 182). The system 10 defines StartEnd by assigning the starting point a StartEnd value of 2, assigning the ending point a StartEnd value of 3, and assigning all continuation points a StartEnd value of 1. The system 10 then adds the points to the master list (step 184), and returns to step 156 to process the next skeleton. If at step 174, 50% of the crack segments are not between the minimum and maximum, the system 10 discards the crack from the path (step 186), and returns to step 156 to process the next skeleton. After processing all of the skeletons (step 156), the system 10 has generated an initial path 188.

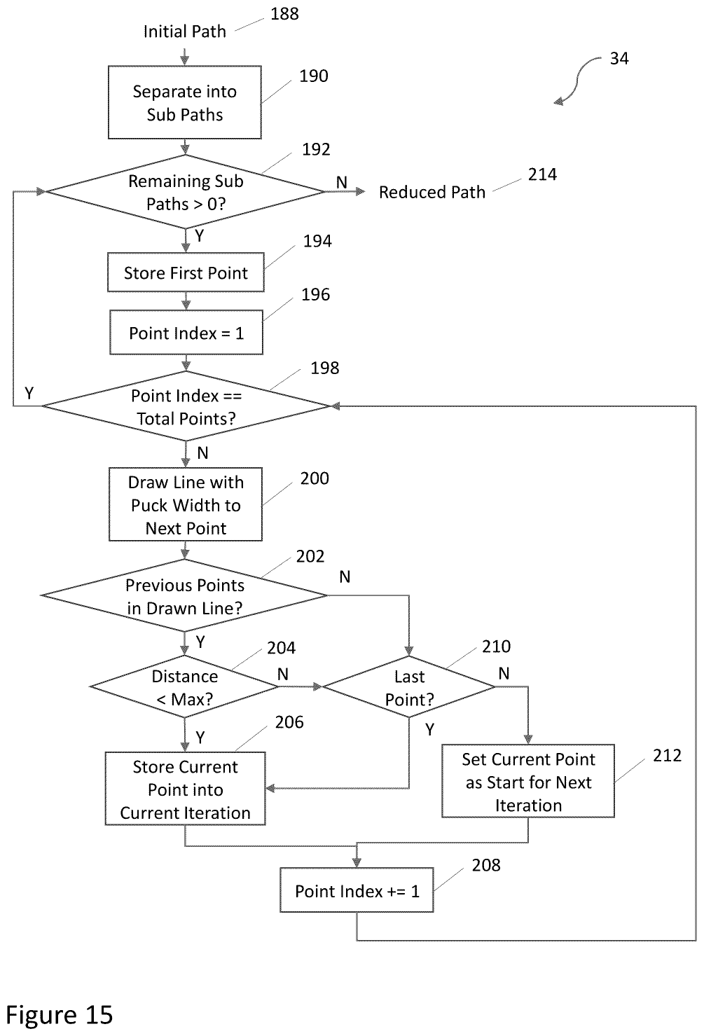

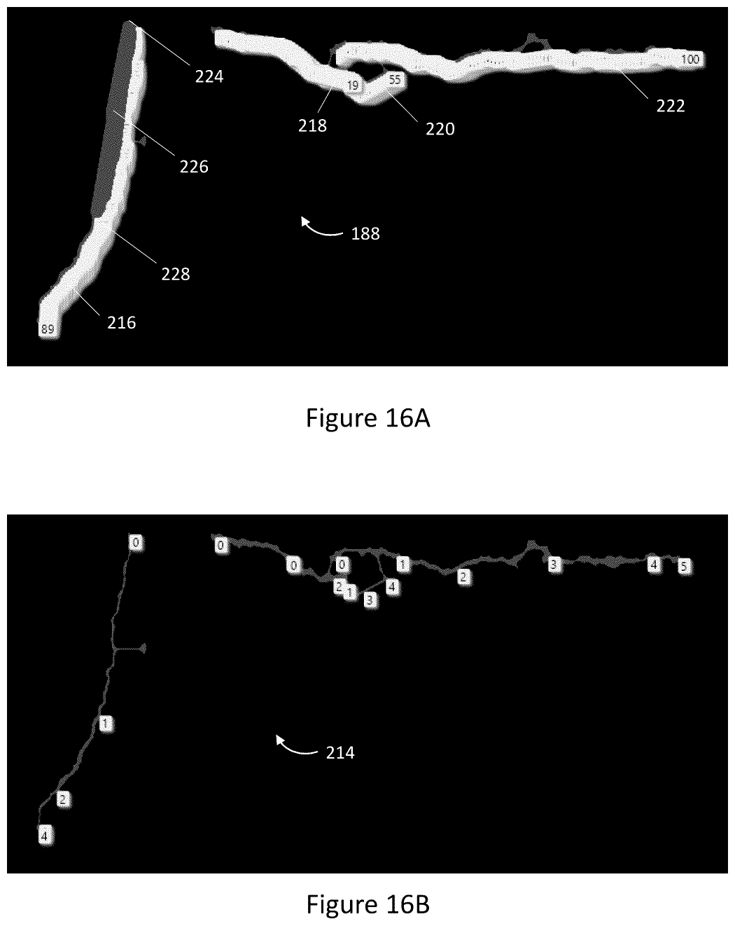

Returning to FIG. 5, after generating the path (step 32), the system 10 reduces the number of points in the path (step 34) by reducing each contour into a series of connected lines, thereby reducing the plurality of points in the path to the endpoints of each of the connected lines. FIG. 15 reflects exemplary steps performed by the system 10 to reduce the number of points in the path. The system 10 initially separates the initial path 188 into sub paths (step 190). For example, referring to FIG. 16A, the system 10 separates the initial path 188 into four independent paths 216, 218, 220, and 222.

Returning to FIG. 15, for each sub path (step 192), the system 10 initially stores the first point to the simplified path (step 194) and initializes a counter (“Point Index”) to ensure each point in the path is evaluated (step 196). The system 10 determines whether the point index equals the total points (step 198). If not, the system 10 draws a line with the puck width from the last stored point to the next point (step 200), and determines whether all previous points are inside the drawn line (step 202). If all of the points are within the drawn line, the system 10 checks to ensure that the distance is less than the maximum distance (step 204). If the distance is less than the maximum distance, the system 10 stores the current point into the current iteration (step 206), and increments the counter (step 208). If at step 202, all previous points are not inside the drawn line, the system 10 determines whether the current point is the last point in the contour (step 210). If the current point is the last point, the system 10 adds it to into the current iteration (step 206) and increments the counter (step 208). If at step 210 the current point is not the last point, the system 10 sets the current point as the start for the next iteration (step 212). In other words, the system 10 uses this point as the “last stored point” for the next iteration of drawn lines. For example, referring to FIG. 16A, on sub path 216, all points between initial point 224 and point 228 align with drawn line 226. Therefore, all points are stored in the same line iteration. The next point after point 228 does not align with drawn line 226, and thus begins a new line iteration.

Returning to FIG. 15, after incrementing the counter (step 208), the system 10 determines whether all of the points in the path have been evaluated (step 198). If at step 198, all points in the path have been evaluated, the system 10 proceeds with processing the next sub path from the initial path 188 (step 192). When all contours have been processed, the system 10 has identified a reduced path 214. FIG. 16B illustrates the reduced path 214. For each sub path 216, 218, 220, 222, Point 0 to Point 1 identifies the first line in the path, Point 1 to Point 2 identifies the second line in the path, etc. For example, sub path 216 has been reduced to four lines: from 0 to 1, from 1 to 2, from 2 to 3 and from 3 to 4.

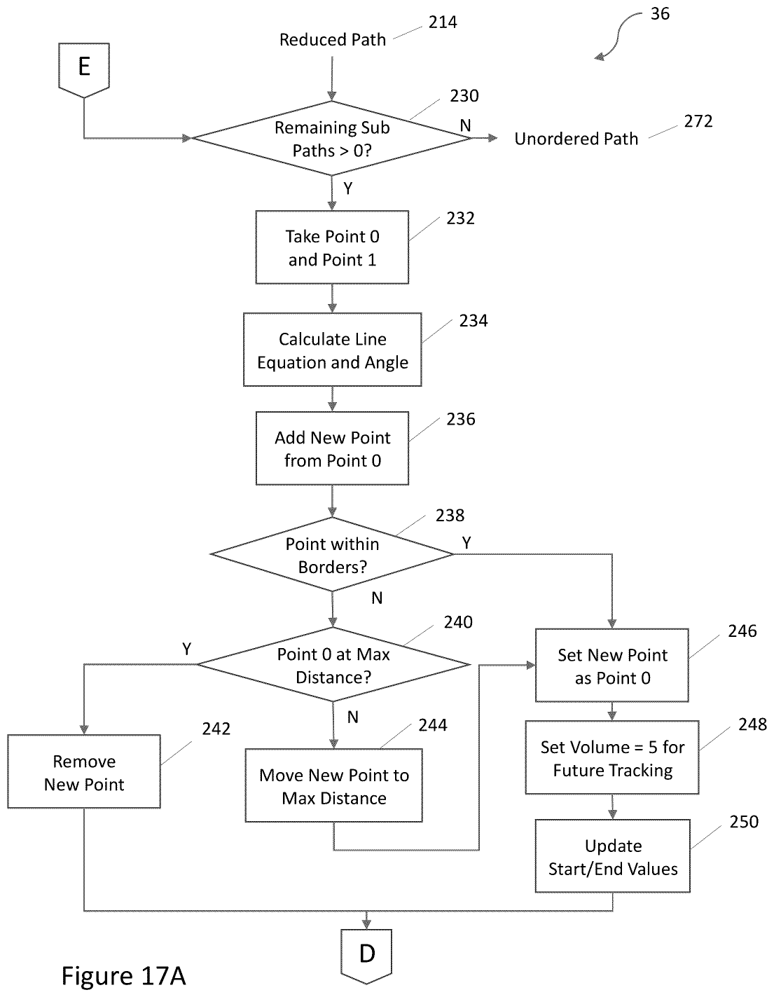

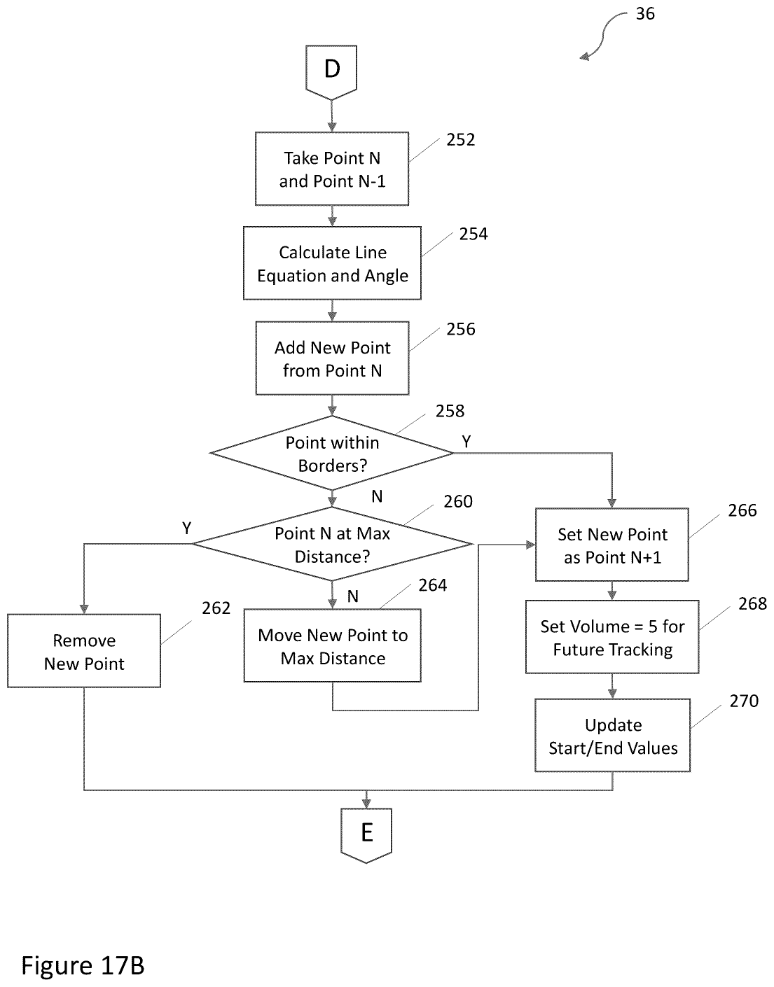

Returning to FIG. 5, after reducing the number of points in the path (step 34), the system 10 ensures that a minimum point density is maintained (step 36). FIGS. 17A-17B reflect exemplary steps performed by the system 10 to ensure that the minimum point density is maintained. For each sub path in the reduced path 114 (step 230), the system 10 takes the first two points in the contour (i.e., Point 0 and Point 1) (step 232) and calculates a line equation and angle from point to point (step 234). Within the same line, the system 10 adds a new point at an extra distance from Point 0 (step 236), and determines whether the point is within borders (step 238). If the point is not within borders, the system 10 determines whether Point 0 is at a maximum possible distance within the borders (step 240) If Point 0 is at the maximum possible distance, the system 10 removes the new point (step 242). Otherwise, the system 10 moves the new point to the maximum possible distance within the borders (step 244). The system 10 then sets the new point as Point 0 (step 246). The system 10 also sets the new point as Point 0 (step 246) if at step 238 it determined that the point was within the borders. The system 10 then sets volume to 5 for future tracking (step 248), and updates the start/end values (step 250) by incrementing the point values (i.e., setting previous Point 0 to Point 1, setting Point 1 to Point 2, etc.) and changing the previous Point 0 to a continuation point rather than a start point.

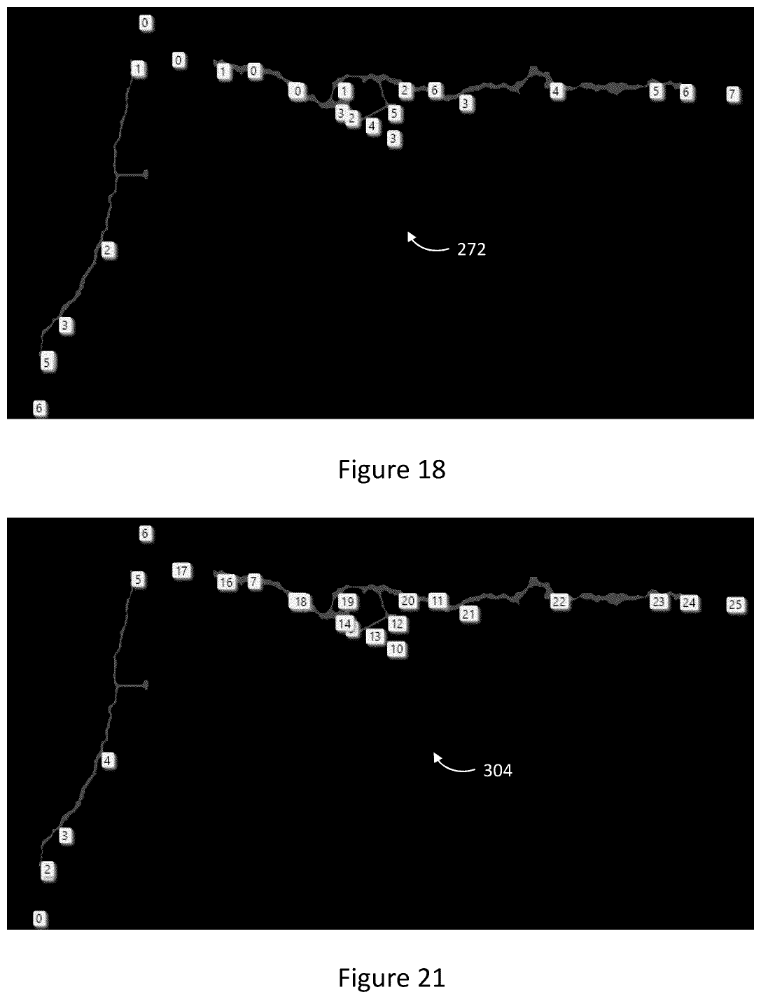

Referring to FIG. 17B, the system 10 also performs the same steps for the end of the contour. The system 10 takes Point N and Point N−1 (step 252) and calculates a line equation and angle from point to point (step 254). Within the same line, the system 10 adds a new point at an extra distance from Point N (step 256), and determines whether the point is within borders (step 258). If the point is not within borders, the system 10 determines whether Point N is at a maximum possible distance within the borders (step 260) If Point N is at the maximum possible distance, the system 10 removes the new point (step 262). Otherwise, the system 10 moves the new point to the maximum possible distance within the borders (step 264). The system 10 then sets the new point as Point N+1 (step 266). The system 10 also sets the new point as Point N+1 (step 266) if at step 258 it determined that the point was within the borders. The system 10 then sets volume to 5 for future tracking (step 268), and updates the start/end values (step 270) by changing Point N to a continuation point rather than an end point. The system 10 then returns to step 230 to process the next sub path from the reduced path 214. When all sub paths have been processed, the system 10 has identified an unordered path 272, reflected in FIG. 18.

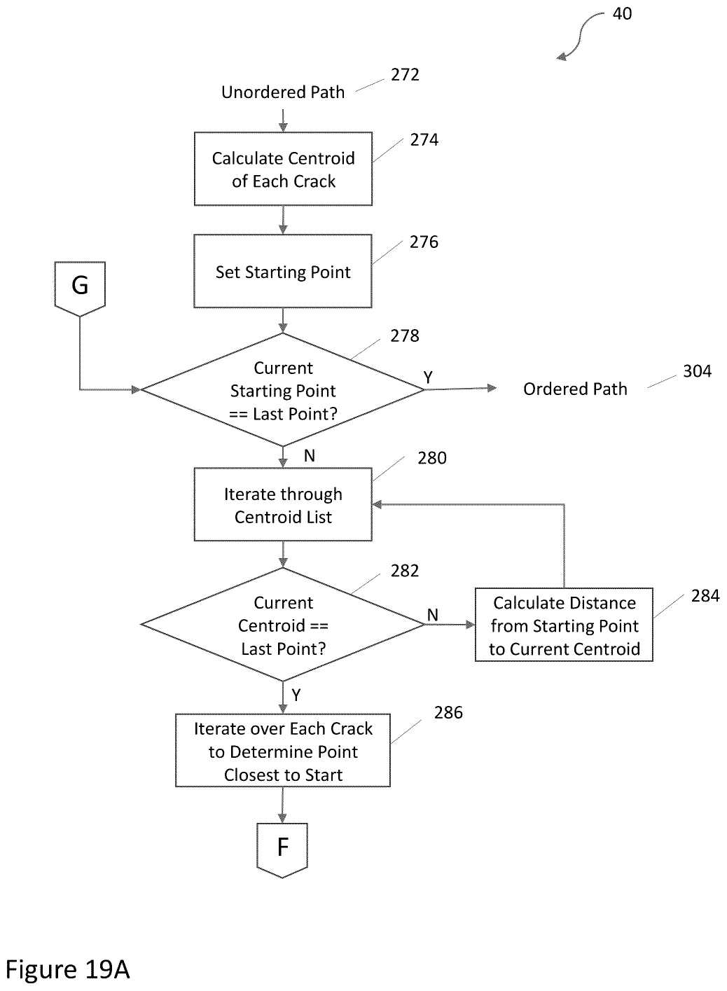

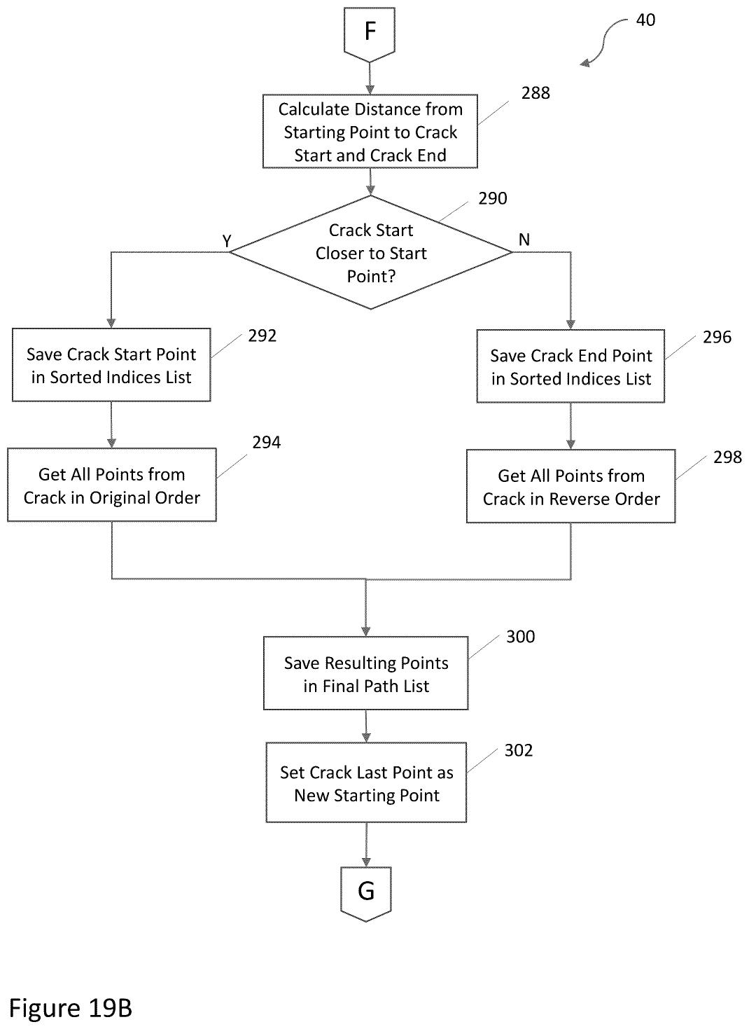

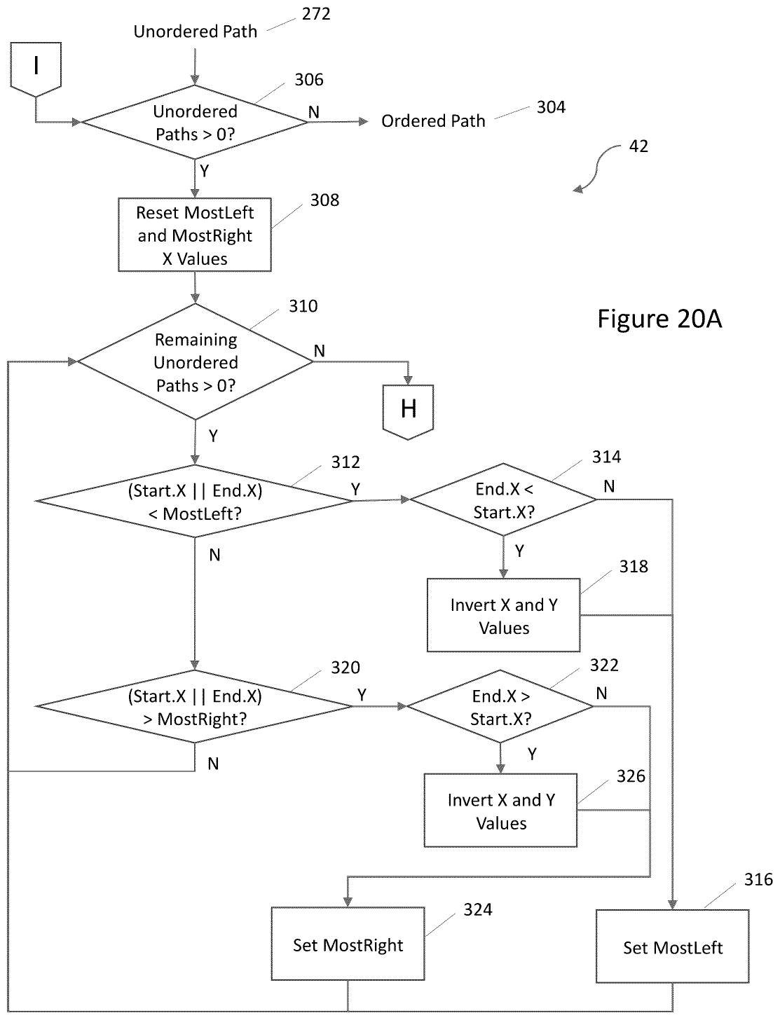

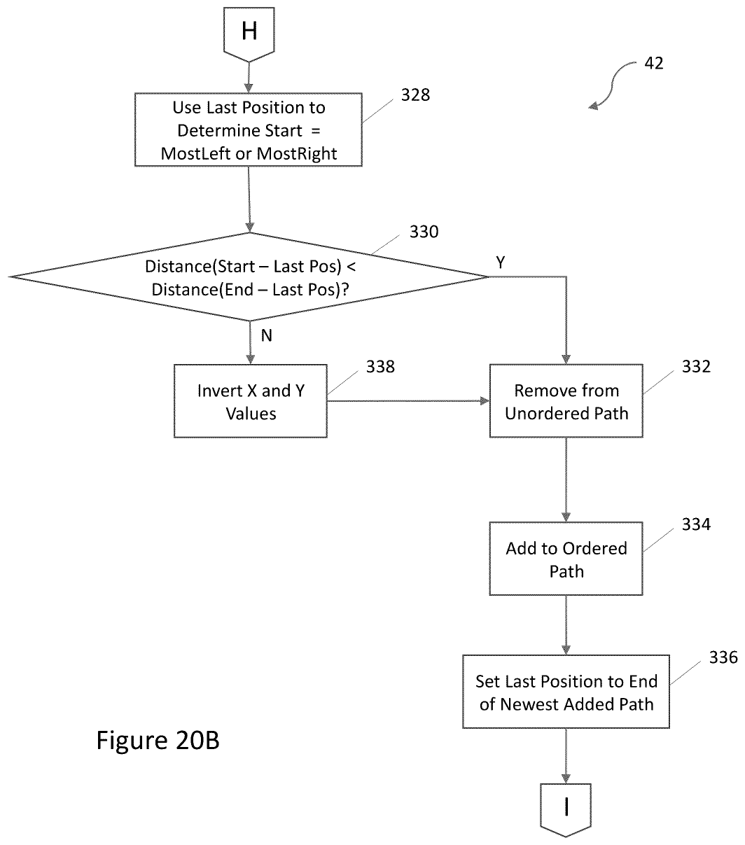

Returning to FIG. 5, after ensuring that the minimum point density is maintained (step 36), the system 10 determines whether the path has more than two cracks (step 38). If the path has more than two cracks, the system 10 optimizes the path by placing the cracks in order based on the distance of the centroid of the crack to the last known position of the robot (step 40). If the path does not have more than two cracks the system 10 orders the path based on the distance of one of the ends of the crack to the last known position of the robot (step 42). FIG. 19A-19B reflect exemplary steps performed by the system 10 to optimize the path, while FIGS. 20A-20B reflects exemplary steps performed by the system 10 to order the path.

Referring to FIG. 19A, to optimize the path, the system 10 initially calculates the centroid of each crack in the unordered path 272 (step 274). The system 10 sets the last known robot position as the starting point (step 276). The system 10 then determines whether the current starting point is the last point in the list (step 278). If the current starting point is not the last point in the list, the system 10 iterates through the centroid list (step 280) and determines whether the current centroid is the last point in the list (step 282). If the current centroid is not the last point in the list, the system 10 calculates the distance from the starting point to the current centroid (step 284). Otherwise, the system 10 iterates over each crack to determine if the initial point on the crack or the last point on the crack is closest to the starting point (step 286).

Referring to FIG. 19B, the system 10 then calculates the distance from the starting point to the crack start and crack end points (step 288). The system 10 then determines whether the crack start point is closer to the starting point (step 290). If the crack start point is closer to the starting point, the system 10 saves the crack start point in the sorted indices list (step 292) and gets all points from that crack in the original order (step 294). If the crack start point is not closer to the starting point, the system 10 saves the crack end point in the sorted indices list (step 296) and gets all points from that crack in reverse order (step 298). The system 10 then saves the resulting points in the final path list (step 300), sets the crack last point as the new starting point (step 302), and returns to step to 278 in FIG. 19A to determine whether the current starting point is the last point in the list. If at step 278 the system 10 determines that the current starting point is the last point in the list, the system 10 returns the ordered path 304, as reflected in FIG. 21.

Referring to FIG. 20A, to order the path, while each path is classified as an unordered path (step 306), the system 10 initially resets the MostLeft and MostRight X Values (step 308). For each unordered path (step 310), the system 10 determines whether either the start X position or the end X position is more left than the MostLeft position (step 312). If either the start X position or the end X position is more left than the MostLeft position, the system 10 determines whether the end X position is more left than the start X position (step 314). If the end X position is not more left than the start X position, the system 10 sets the start X position as the MostLeft X value (step 316). If the end X position is more left than the start X position, the system 10 inverts the X and Y values (step 318) before setting the start X position as MostLeft X value (step 316). The system 10 then returns to step 310 to process any remaining unordered paths.

If at step 312, the system 10 determines that neither the start X position or the end X position is more left than the MostLeft position, the system 10 determines whether either the start X position or the end X position is more right than the MostRight position (step 320). If either the start X position or the end X position is more right than the MostRight position, the system 10 determines whether the end X position is more right than the start X position (step 322). If the end X position is not more right than the start X position, the system 10 sets the start X position as the MostRight X value (step 324). If the end X position is more right than the start X position, the system 10 inverts the X and Y values (step 326) before setting the start X position as the MostRight X value (step 324). The system 10 then returns to step 310 to process any remaining unordered paths. The system 10 also returns to step 310 to process any remaining unordered paths if at step 320, it determines that neither the start X position nor the end X position is more right than the MostRight position.

After the system 10 processes all of the unordered paths (step 310), the system 10 uses the last known position of the robot to determine whether to start with the left-most or the right-most path (step 328, FIG. 20B). The system 10 determines whether the distance between the start of the path and the last known position of the robot is less than the distance between the end of the path and the last known position of the robot (step 330). If so, the system 10 removes the path from the unordered paths (step 332), adds it to the ordered paths (step 334), and sets the last known position of the robot arm to the end of the newest added path (step 336). If at step 330 the distance from the robot arm to the end of the path is closer than the distance from the robot arm to the start of the path, the system 10 inverts the X and Y values (step 338) before removing the path from unordered paths (step 332), adding it to the ordered paths (step 334), and setting the last known position of the robot arm to the end of the newest added path (step 336). The system 10 then returns to step 306 in FIG. 19A to determine whether there are any remaining unordered paths. After all unordered paths have been converted to ordered paths (step 306), the system 10 returns the ordered path 304.

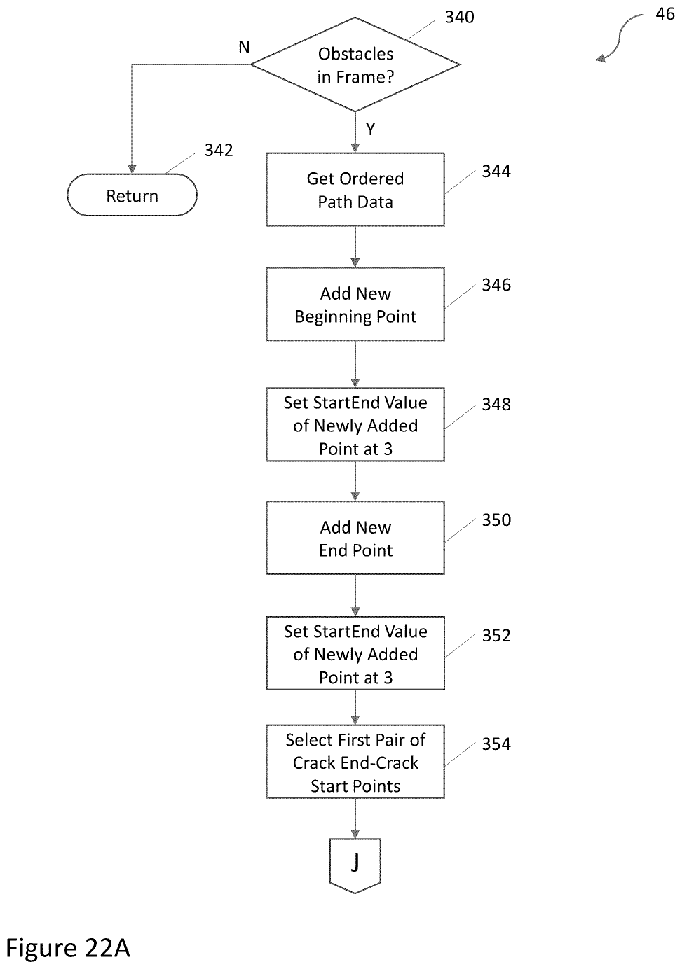

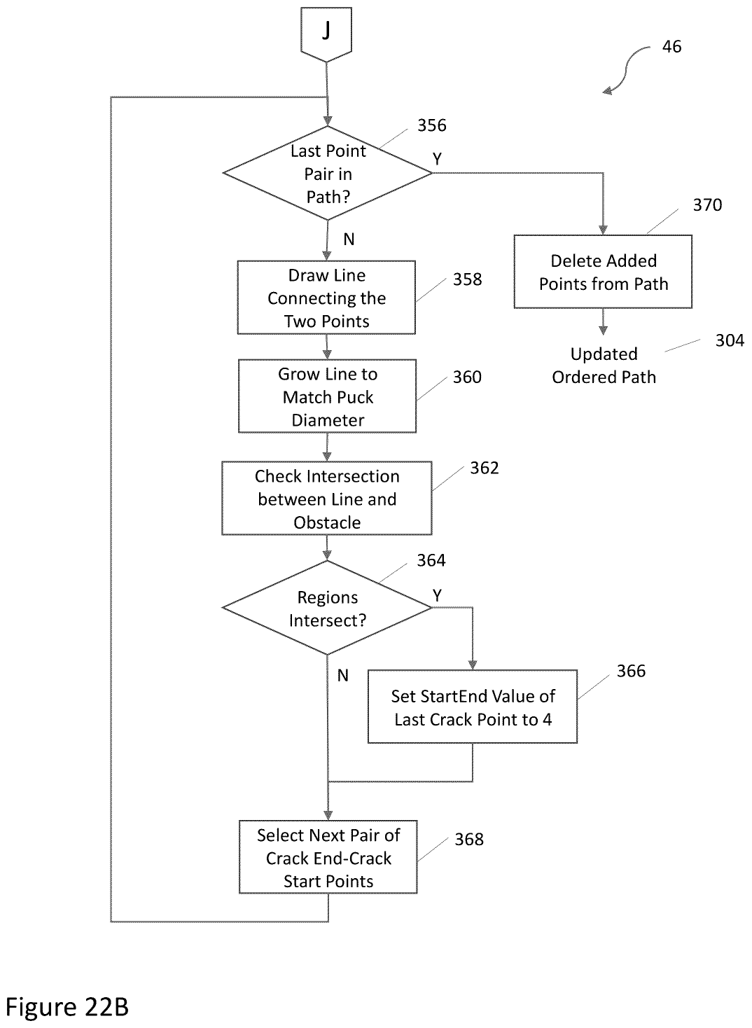

Returning to FIG. 5, after either optimizing the path (step 40) or ordering the path (step 42), the system 10 sets the volume to 0 for the first and last points of each crack to ensure that the nozzle is turned off as the robot proceeds from one crack to the next (step 44). The system 10 then checks for obstacles (step 46). FIGS. 22A-22B reflect exemplary steps performed by the system 10 to check for obstacles. The system 10 initially determines whether any obstacles are in the frame (step 340). If no obstacles are in the frame, the system 10 returns to the overall process in FIG. 5 (step 342).

If obstacles are in the frame, the system 10 gets the ordered path data, including the path points, the StartEnd values and the volume (step 344). The system 10 adds the last known robot position as a new point at the beginning of the path (step 346) and sets the StartEnd value of the newly added point at 3, reflecting that it is a crack end (step 348). The system 10 also adds a new point to the path on a straight line from the last point to the end of the frame (step 350) and sets the StartEnd value of the newly added point at 3, reflecting that it is a crack end (step 352). The system 10 then selects the end point of the first crack and the start point of the following crack (step 354), and determines whether this pair of crack end-crack start points is the last point pair in the path (step 356, FIG. 22B). If pair of crack end-crack start points is not the last point pair in the path, the system 10 draws a straight line connecting the two points (step 358), grows the line to match the diameter of the puck (step 360), and checks the intersection between the line region and any obstacles in the frame (step 362). If the system 10 determines that the line region intersects with any obstacles in the frame (step 364), the system 10 sets the StartEnd value of the last point of the crack to 4 to notify the robot that it must lift the tool while traveling along the path in order to avoid the obstacle (step 366). The system 10 then selects the next pair of crack end-crack start points (step 368). The system 10 also selects the next pair of crack end-crack start points (step 368) if at step 364 it determines that the line region does not intersect with any obstacles in the frame. The system 10 then returns to step 356 to determine whether the next pair of crack end-crack start points is the last point pair in the path. If at step 356, the system 10 determines that the pair of crack end-crack start points is the last point pair in the path, the system 10 deletes the points that were added at steps 346 and 350 from the path (step 370) and returns the updated ordered path 304.

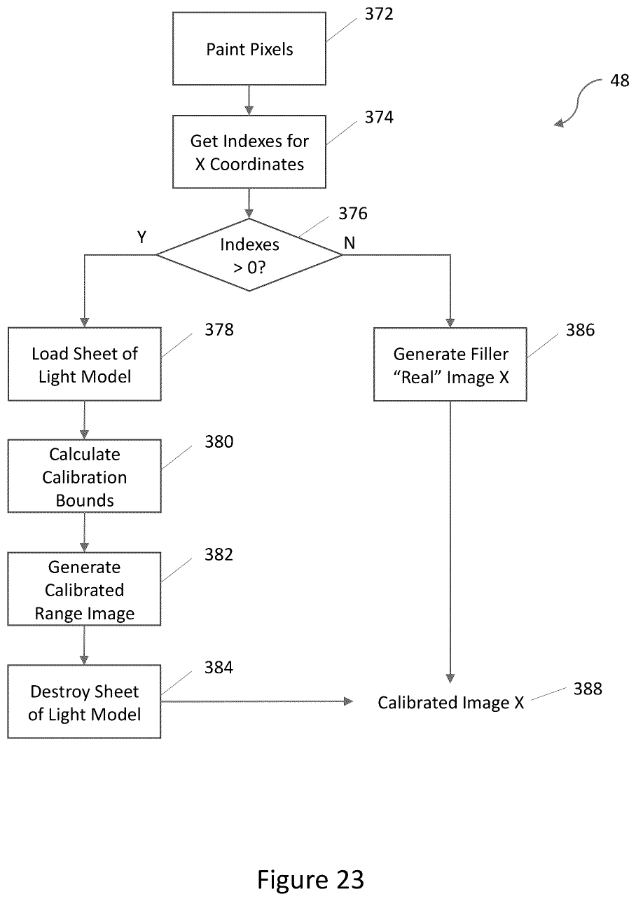

Returning to FIG. 5, after checking for obstacles (step 46), the system 10 performs point calibration (step 48). FIG. 23 reflects exemplary steps performed by the system 10 to perform point calibration. The system 10 initially uses a threshold of 0 to 1 and paints the pixels with a 1 to remove noise (step 372). The system 10 gets the indexes for all points for which X coordinates exist in the current camera (step 374). In other words, the system 10 obtains the indexes for any points that require crack filling. The system 10 then determines whether indexes >0 (step 376). If indexes is greater than 0, the system 10 loads a sheet of light model (step 378). The system 10 calculates calibration bounds (step 380), generates a calibrated range image (step 382), and destroys the sheet of light model (step 384) before returning the calibrated image X 388. If at step 376, the system 10 determines that there are no indexes, the system 10 generates a filler “real” image X (step 386) before returning the calibrated image X 388.

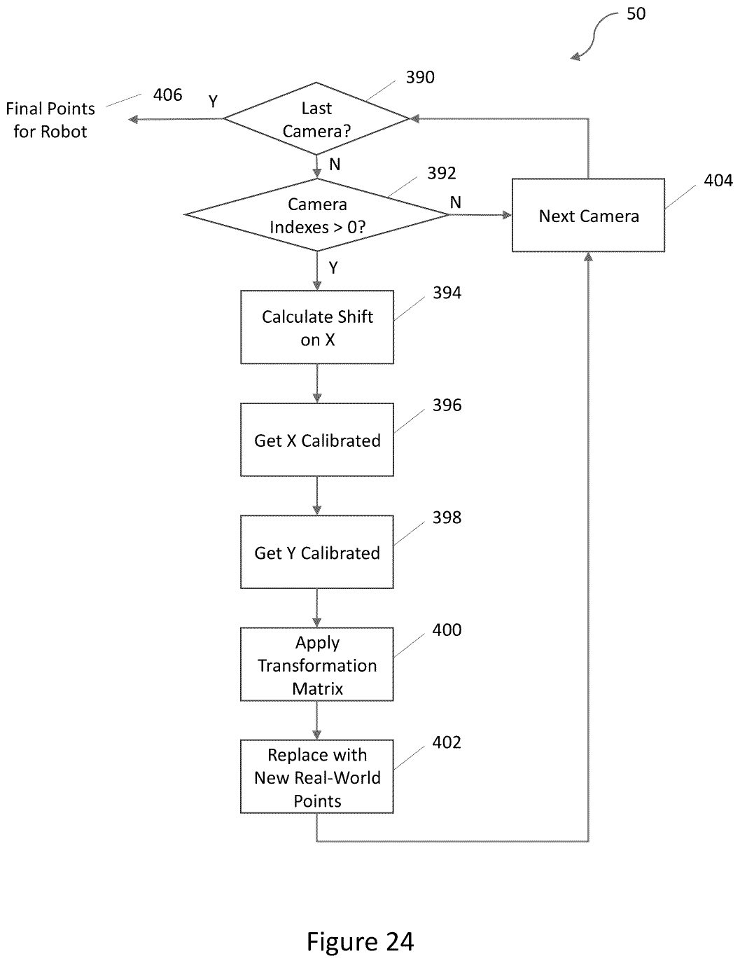

Returning to FIG. 5, after point calibration (step 48), the system 10 converts the coordinates to real world coordinates for the robot to follow (step 50). FIG. 24 reflects exemplary steps performed by the system 10 to convert the coordinates into real world coordinates. For each camera (step 390), the system 10 determines whether there is at least one index for the camera (step 392). If there is at least one index for the camera, the system 10 calculates the shift on the X, which depends on the camera number and the image width (step 394). The system 10 gets the X calibrated by getting the pixel values of the X image along each crack point (step 396). The system 10 gets the Y calibrated by multiplying the crack point by a Y resolution (step 398), and applies a corresponding transformation matrix to the crack points (step 400). The system 10 then replaces the final path with the new real-world points (step 402) before processing the next camera (step 404). When all cameras have been processed, the system 10 returns the final points for the robot 406.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. A method for programming a robot to autonomously fill cracks in a pavement, wherein the robot fills the cracks using a nozzle having a puck width, the method comprising the steps of:
obtaining an image of the pavement;
identifying one or more crack regions in the pavement from the image;
generating a path to fill the one or more crack regions;
determining a volume of sealant to fill the one or more crack regions along the path;
generating instructions to fill the one or more crack regions using the path and the volume of the sealant; and
sending the instructions to the robot.

2. The method of claim 1, wherein the step of identifying the one or more crack regions comprises the steps of:
preprocessing the image to generate a pre-processed image;
applying an AI deep learning model to the pre-processed image to obtain a segmented image; and
postprocessing the segmented image to identify the one or more crack regions.

3. The method of claim 2, further comprising the steps of:
identifying an obstacle in the image; and
ensuring that the robot avoids filling the obstacle with sealant.

4. The method of claim 3, wherein the step of ensuring that the robot avoids filling the obstacle with sealant comprises the steps of:
determining whether the obstacle intersects the path; and
if it is determined that the obstacle intersects the path, instructing the robot to lift the nozzle to avoid the obstacle.

5. The method of claim 2, wherein the step of generating the path comprises the steps of:
eroding each of the one or more crack regions into a skeleton section; and
for each skeleton section:
pruning small branches off the skeleton section;
converting the skeleton section into a plurality of points;
generating X and Y coordinates for each of the plurality of points; and
categorizing each of the plurality of points as a starting point, an ending point or a continuation point.

6. The method of claim 5, wherein the step of generating the path comprises the steps of:
dividing each of the one or more crack regions into a plurality of segments;
determining a cross-sectional value for each of the plurality of segments; and
classifying each of the plurality of segments based on the cross-sectional value.

7. The method of claim 6, further comprising the steps of:
for each skeleton section:
drawing a line having a width equal to the puck width from one of the plurality of points to another of the plurality of points;
determining if all of the plurality of points between the one point and the other point lie along the line; and
if it is determined that all of the plurality of points lie along the line, replacing all of the plurality of points with the one and the other of the plurality of points.

8. The method of claim 2, wherein the step of generating the path comprises the steps of:
receiving a last known position of the robot; and
for each of the one or more crack regions:
determining a centroid for each of the crack regions;
determining which of the centroids is closest to the last known position of the robot; and
ordering the one or more crack regions based on the distance between the corresponding centroid and the last known position of the robot.

9. A system for programming a robot to autonomously fill cracks in a pavement, wherein the robot fills the cracks using a nozzle having a puck width, the system comprising:
a camera configured to obtain an image of the pavement; and
a processor configured to:
identify one or more crack regions in the pavement from the image;
generate a path to fill the one or more crack regions;
determine a volume of sealant to fill the one or more crack regions along the path;
generate instructions to fill the one or more crack regions using the path and the volume of the sealant; and
send the instructions to the robot.

10. The system of claim 9, wherein to identify the one or more crack regions, the processor is configured to:
preprocess the image to generate a pre-processed image;
apply an AI deep learning model to the pre-processed image to obtain a segmented image; and
postprocess the segmented image to identify the one or more crack regions.

11. The system of claim 10, wherein the processor is configured to:
identify an obstacle in the image; and
ensure that the robot avoids filling the obstacle with sealant.

12. The system of claim 11, wherein to ensure that the robot avoids filling the obstacle with sealant, the processor is configured to:
determine whether the obstacle intersects the path; and
if the processor determines that the obstacle intersects the path, the processor is configured to instruct the robot to lift the nozzle to avoid the obstacle.

13. The system of claim 12, wherein to generate the path, the processor is configured to:
erode each of the one or more crack regions into a skeleton section; and
for each skeleton section, the processor is configured to:
prune small branches off the skeleton section;
convert the skeleton section into a plurality of points;
generate X and Y coordinates for each of the plurality of points; and
categorize each of the plurality of points as a starting point, an ending point or a continuation point.

14. The system of claim 12, wherein to generate the path, the processor is configured to:
divide each of the one or more crack regions into a plurality of segments;
determine a cross-sectional value for each of the plurality of segments; and
classify each of the plurality of segments based on the cross-sectional value.

15. The system of claim 16, wherein for each skeleton section, the processor is configured to:
draw a line having a width equal to the puck width from one of the plurality of points to another of the plurality of points;
determine if all of the plurality of points between the one point and the other point lie along the line; and
if the processor determines that all of the plurality of points lie along the line, the processor is configured to replace all of the plurality of points with the one and the other of the plurality of points.

16. The system of claim 12, wherein to generate the path, the processor is configured to:
receive a last known position of the robot; and
for each of the one or more crack regions, the processor is configured to:
determine a centroid for each of the crack regions;
determine which of the centroids is closest to the last known position of the robot; and
order the one or more crack regions based on the distance between the corresponding centroid and the last known position of the robot.
